(19) United States
(12) Patent Application Publication
(10) Pub. No.: US 2007/0105449 A1
(43) Pub. Date: May 10, 2007

(54) Contact holding structure of connector

(76) Inventor: Rysuke Murayama, Tokyo (JP)

Correspondence Address: WILLIAM COLLARD;COLLARD & ROE, P.C., 1077 NORTHERN BOULEVARD, ROSLYN, NY, 11576, US

(21) Appl. No.: 10/583,748

(22) PCT Filed: Dec. 13, 2004
(86) PCT No.: PCT/JP04/18565

§ 371 Date: Aug. 16, 2006

(30) Foreign Application Priority Data
Dec. 22, 2003 (JP) 2003-424880

(51) Int. Cl. H01R 24/00

(52) U.S. Cl. 439/637

(57) ABSTRACT

A simply formed and rigid contact holding structure of a connector in which the positions of the contact parts of a plurality of contacts are different from each other.

When the contact (3) is deeply fitted into an insulator (2), first the contact is inserted into a contact storage part (2a) in the direction of an arrow in step 1. Next, a holder (8) is inserted into a holder storage part (2b) in the direction of an arrow in step 2, and an engagement part (8a) is engaged with a latch (engaged part) (3d2). Then, the contact is fixed to the insulator. When the contact is shallowly fitted into the insulator, the engagement part is engaged with the latch (3d1). As a result, a position difference is formed in the fitting direction of the connector between the contact part (3a) of the contact in the first case and the contact part of the contact in the second case.

### TECHNICAL FIELD

This invention relates to a structure for holding contacts by an insulator in a connector and, more specifically, relates to a connector that can firmly hold a plurality of the same contacts by an insulator and further that can change a position of each contact with respect to the insulator.

### BACKGROUND ART

Referring to FIGS. 8 to 10, description will be made about contact holding structures of first conventional connectors.

At first, a plug connector 21 will be described. A contact 23 is continuously and integrally formed by a contact portion 23a having a projected shape, a spring portion 23b, a holding portion (press-fitting portion) 23c to be held by an insulator 22, and a connecting portion 23d where an electric wire of a cable (not shown) is soldered, in the order named from the tip end. The holding portion 23c is formed with two latches 23c1 and 23c2.

A contact receiving portion 22a is formed through the insulator 22 from its front to back. Further, the outer periphery of the insulator 22 is covered with a shell 24.

When the contact 23 is inserted into the receiving portion 22a, the respective latches 23c1 and 23c2 of the contact 23 engage with the receiving portion 22a so that the contact 23 is fixed to the insulator 22.

Next, a receptacle connector 31 will be described. A contact 33 is continuously and integrally formed by a linear contact portion 33a, a linear holding portion (press-fitting portion) 33b to be held by an insulator 32, and a generally L-shaped connecting portion 33c, in the order named from the tip end. The insulator 32 is formed with a pass-through receiving portion 32a and a support portion 32b continuous with the receiving portion 32a. The outer periphery of the insulator 32 is covered with a tubular shell 34.

When the contact 33 is inserted into the receiving portion 32a, the holding portion 33b is fixed to the receiving portion 32a and the contact portion 33a is supported by the support portion 32b.

When the plug connector 21 is fitted into the receptacle connector 31, the contact portion 23a of the contact 23 is brought into contact with the contact portion 33a of the contact 33 and the shell 24 is brought into contact with the shell 34.

A contact holding structure of a second conventional connector will be described (e.g. see Patent Document 1).

FIG. 11, (A) shows a state before assembly of a male connector, while FIG. 11, (B) shows a state after the assembly of the mail connector.

An insulator 42 of a male connector 41 is formed with through holes 42a at three positions and the same contacts 43 are inserted into the respective through holes 42a. Each contact 43 has a flange 43a. After attaching a stepped plate 44 to the insulator 42, the contacts 43 are press-fitted into the insulator 42. Then, since the flanges 43a of the contacts 43 abut against the insulator 42, a lower step of the stepped plate 44, and a higher step thereof, respectively, in order from the left side, the lengths of the contacts 43 differ from each other in the insulator 42.

In this manner, in order to prevent influence on the contacts due to power supply voltage fluctuation when connection or disconnection is performed between electronic circuit boards that are turned on and thus in an operating state, it is configured that a time difference occurs in connection or disconnection between the contacts of the connector connecting between the electronic circuit boards.

Incidentally, in a hot-swap connector, for the purpose of an IC destruction prevention measure, a low insertion force of the connector, and so on upon hot swap (insertion or removal of a package in the energized state), the order of insertion or removal, i.e. the sequence, is set, for example, in three stages (ground terminal, power supply terminal, and signal terminal).

Patent Document 1: Japanese Patent No. 2973924 (page 3, paragraph 5, line 26 to paragraph 6, line 3, FIGS. 1 to 3)

### DISCLOSURE OF THE INVENTION

### Problem to be Solved by the Invention

In the contact holding structure of the first conventional connector as described above, the contact 23 is fixed to the insulator 22 by the engagement of the latches 23c1 and 23c2 of the contact 23 into the receiving portion 22a. Therefore, the contact 23 easily comes off the insulator 22 due to an accidental external force.

In the contact holding structure of the second conventional connector as described above, the excessive member, i.e. the dedicated stepped plate 44, is employed for causing the position of a contact portion of the contact 43 to differ from the positions of contact portions of the other contacts 43. Further, since the contacts 43 are inserted into the respective through holes 42a of the insulator 42 by the means such as press-fitting, the contacts easily come off the insulator 42 due to an accidental external force.

Therefore, this invention improves the defects of both of the foregoing conventional techniques and provides a contact holding structure that is simple in structure and yet is rigid, in a connector where the positions of contact portions of a plurality of contacts differ from each other.

### MEANS FOR SOLVING THE PROBLEM

This invention adopts the following means in order to solve the foregoing problems.

1. A contact holding structure of a connector comprising a plurality of contacts each having a contact portion to be connected to a mating side, an insulator formed with a contact receiving portion receiving therein part of each of said contacts, and a holder, said contact holding structure characterized in that

said part of each contact is formed with a plurality of to-be-engaged portions at different positions in a fitting direction of said connector,

said insulator is formed with a holder receiving portion continuous with said contact receiving portion and adapted to receive therein said holder,

said holder has an engaging portion and is adapted to be mounted into said holder receiving portion in a direction crossing the fitting direction of said connector,

said holder is mounted into said holder receiving portion after said part of each contact is mounted in said contact receiving portion, so that said engaging portion engages with one of said to-be-engaged portions to thereby fix said part of each contact to said insulator, and

positions of the contact portions of part of said contacts are caused to differ from positions of the contact portions of the other contacts in the fitting direction of said connector.

2. The contact holding structure of a connector according to the above 1, characterized in that said part of each contact is further provided with a portion press-fitted into said insulator.

3. The contact holding structure of a connector according to the above 1, characterized in that said plurality of contacts are arranged in said insulator in two rows facing each other, two holders are provided in said insulator, and said holders engage with said plurality of contacts in the two rows, respectively.

### EFFECT OF THE INVENTION

As clear from the description of the specification, this invention exhibits the following effects.

1. Even when the plurality of the same contacts (which, however, differ only in position of connecting portions) are employed, it is possible to cope with hot swap by forming the plurality of to-be-engaged portions at different positions in the fitting direction of the connector. Only by shifting the insertion positions while commonly using the components, the positions of the contact portions of the optional contacts and the positions of the contact portions of the other contacts can differ from each other.

2. By the engagement between the engaging portion of the holder and the to-be-engaged portion of the contact and further by the press-fitting of the press-fitting portion of the contact into the insulator, the contact is prevented from accidentally coming off the insulator.

3. The number of components does not increase, the structure is simple, rigid, and compact, the assembly and disassembly are easy, and further, the cost is low.

### BRIEF DESCRIPTION OF THE DRAWINGS

FIG. 1 is a perspective view, as seen from the front side, of a plug connector according to Embodiment 1 of this invention.

FIG. 2 is a perspective view, as seen from the rear side, of the plug connector before attaching a hood and so on.

FIG. 3 is a perspective view, as seen from the rear side, of the plug connector before a holder is attached to an insulator.

FIG. 4 is a perspective view, as seen from the rear side, of the plug connector with the holder attached to the insulator.

FIG. 5 is a sectional view showing the state before a contact is mounted in the insulator.

FIG. 6 is a sectional view showing the state where the contact is mounted in the insulator, wherein the upper side shows the state where the contact is deeply fitted and the lower side shows the state where the contact is shallowly fitted.

FIG. 7 is a sectional view showing the state where contacts are mounted in an insulator in a plug connector according to Embodiment 2 of this invention.

FIG. 8 is a sectional view showing the state before a plug connector and a receptacle connector are fitted together in the first conventional connectors.

FIG. 9 is a sectional view showing the state where the plug connector and the receptacle connector are fitted together.

FIG. 10 is a sectional view showing the state before a contact is mounted in an insulator in the plug connector.

FIG. 11 is a sectional view showing the states before and after assembly of a male connector in the second conventional connector, wherein (A) shows the state before the assembly and (B) shows the state after the assembly.

### DESCRIPTION OF SYMBOLS

1 plug connector
2 insulator
2a contact receiving portion
2b holder receiving portion
3 contact
3a contact portion
3b spring portion
3c holding portion (press-fitting portion)
3d positioning portion
3d1 latch (to-be-engaged portion)
3d2 latch (to-be-engaged portion)
3e connecting portion
4 fitting portion
5 shell
6 cable
7 hood
8 holder
8a engaging portion
9 lock member

### BEST MODE FOR CARRYING OUT THE INVENTION

Description will be made about contact holding structures of connectors according to two embodiments of this invention.

### Embodiment 1

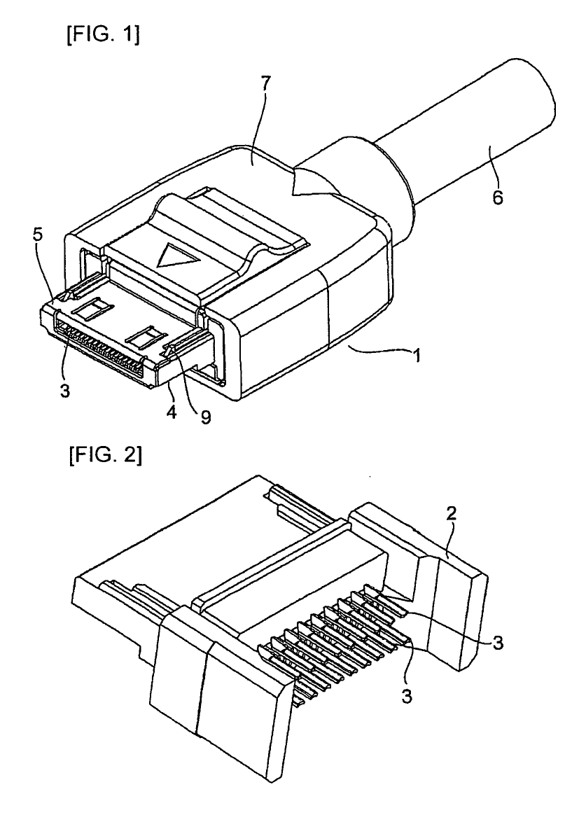

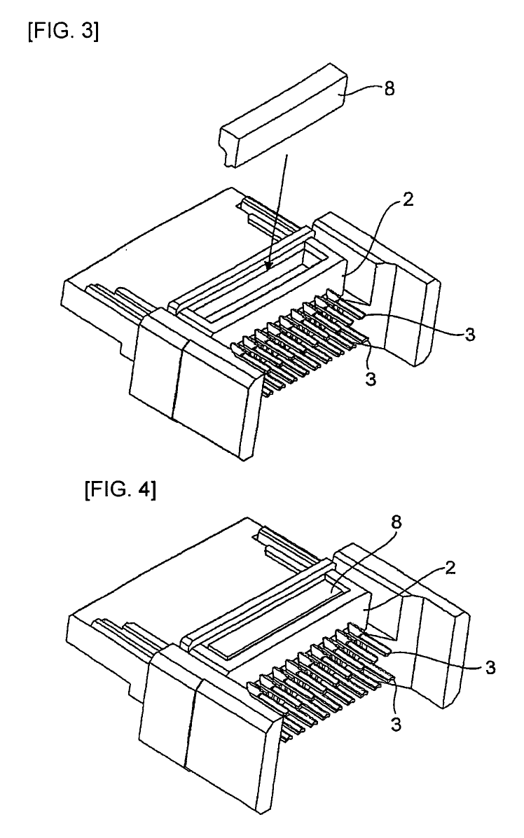

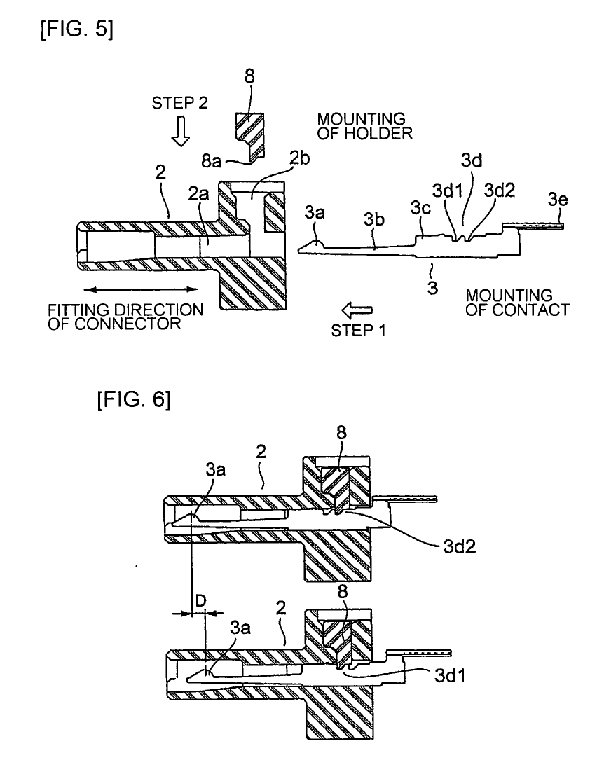

Referring to FIGS. 1 to 6, description will be made about a plug connector of Embodiment 1 of this invention. FIG. 1 is a perspective view, as seen from the front side, of the plug connector, FIG. 2 is a perspective view, as seen from the rear side, of the plug connector before mounting a hood and so on, FIG. 3 is a perspective view, as seen from the rear side, of the plug connector before a holder (a member for fixing respective contacts to an insulator) is attached to the insulator, FIG. 4 is a perspective view, as seen from the rear side, of the plug connector with the holder attached to the insulator, FIG. 5 is a sectional view showing the state before the contact is mounted in the insulator, and FIG. 6, on its upper side, is a sectional view showing the state where the contact is deeply fitted into the insulator, while, on its lower side, is a sectional view showing the state where the contact is shallowly fitted into the insulator.

At first, a schematic structure of a plug connector 1 will be described with reference to FIGS. 1 to 4.

A number of the same contacts 3 are held by an insulator 2 at a constant pitch, wherein contact portions 3a are held in a single tier while connecting portions 3e are held alternately in upper and lower two tiers. Lock members 9 are formed on both sides of an upper surface of the insulator 2 at a fitting portion 4 provided on the front side of the plug connector 1. The outer side of the fitting portion 4 is covered with a shell 5. The fitting portion 4 of the plug connector 1 is adapted to be fitted into a fitting portion of a receptacle connector (not shown). A cable 6 is coupled to the insulator 2 on the back side of the plug connector 1 and the contacts 3 are connected to electric wires of the cable 6, respectively. The outer side of the insulator 2 except the fitting portion 4 of the plug connector 1 is covered with a hood 7. A holder 8 will be described later.

Now, referring to FIGS. 5 and 6, description will be made about a method of mounting the contacts 3 in the insulator 2.

The contact 3 is continuously and integrally formed by the contact portion 3a having a projected shape, a spring portion 3b, a holding portion (press-fitting portion) 3c to be held by the insulator 2, a positioning portion 3d formed with two latches (to-be-engaged portions) 3d1 and 3d2, and the connecting portion 3e where the electric wire of the cable 6 is soldered, in the order named from the tip end. Note that the positions of the connecting portions 3e of half the number of the contacts 3 are vertically reversed with respect to the positions of the connecting portions 3e of the other half of the contacts 3.

The insulator 2 has a contact receiving portion 2a extending through the insulator 2 from its front to back portions and further has a holder receiving portion 2b extending from its upper portion to reach the contact receiving portion 2a so as to be perpendicular to the contact receiving portion 2a. The holder 8 to be received into the holder receiving portion 2b has an engaging portion 8a at its lower part.

When deeply fitting the contact 3 into the insulator 2, the contact 3 is, at first, inserted into the contact receiving portion 2a in an arrow direction of step 1 in FIG. 5. Next, the holder 8 is inserted into the holder receiving portion 2b in an arrow direction of step 2 so as to engage the engaging portion 8a with the latch (to-be-engaged portion) 3d2 as shown in the upper figure of FIG. 6. Thereupon, the contact 3 is fixed to the insulator 2. When shallowly fitting the contact 3 into the insulator 2, the engaging portion 8a is engaged with the latch (to-be-engaged portion) 3d1 as shown in the lower figure of FIG. 6. As a result, a position difference D is provided between the contact portion 3a of the contact 3 in the upper figure of FIG. 6 and the contact portion 3a of the contact 3 in the lower figure of FIG. 6.

Therefore, since the contacts 3 shallowly fitted in the insulator 2 in FIGS. 1 to 4 are fixed at the certain position of the insulator 2, the desired position difference D can be provided between the contact portions 3a of the contacts 3 shallowly fitted in the insulator 2 and the contact portions 3a of the contacts 3 deeply fitted in the insulator 2.

Although each contact 3 is formed with the two latches 3d1 and 3d2, three or more latches can be formed.

### Embodiment 2

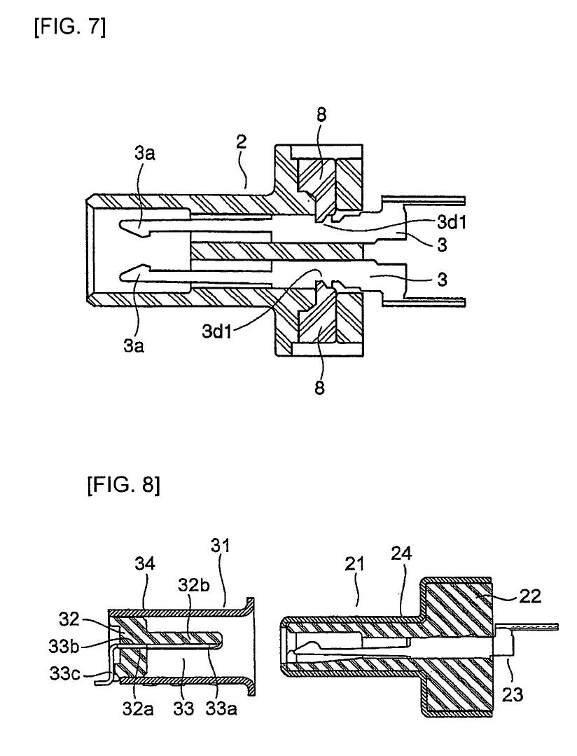

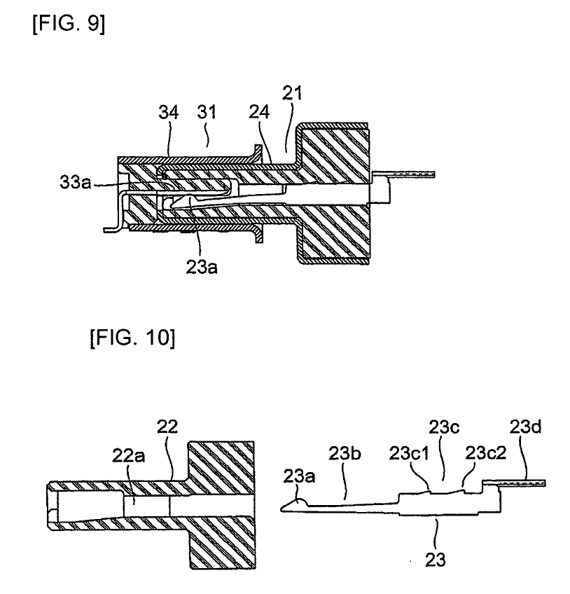

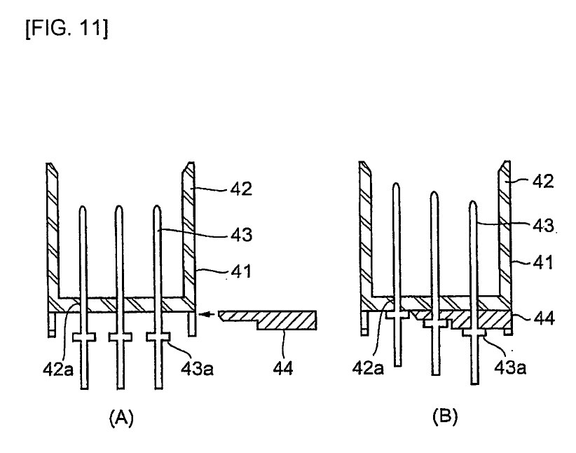

Embodiment 2 of this invention will be described with reference to FIG. 7. In Embodiment 1, the contacts 3 are arranged in a single row. In contrast, in Embodiment 2, contacts 3 are arranged in two rows of upper and lower two tiers so as to face each other and holders 8 are inserted into an insulator 2 in upward and downward two directions.

1. A contact holding structure of a connector comprising a plurality of contacts each having a contact portion to be connected to a mating side, an insulator formed with a contact receiving portion receiving therein part of each of said contacts, and a holder, said contact holding structure characterized in that
said part of each contact is formed with a plurality of to-be-engaged portions at different positions in a fitting direction of said connector,
said insulator is formed with a holder receiving portion continuous with said contact receiving portion and adapted to receive therein said holder,
said holder has an engaging portion and is adapted to be mounted into said holder receiving portion in a direction crossing the fitting direction of said connector,
said holder is mounted into said holder receiving portion after said part of each contact is mounted in said contact receiving portion, so that said engaging portion engages with one of said to-be-engaged portions to thereby fix said part of each contact to said insulator, and
positions of the contact portions of part of said contacts are caused to differ from positions of the contact portions of the other contacts in the fitting direction of said connector.

2. A contact holding structure of a connector according to claim 1, characterized in that said part of each contact is further provided with a portion press-fitted into said insulator.

3. A contact holding structure of a connector according to claim 1, characterized in that said plurality of contacts are arranged in said insulator in two rows facing each other, two holders are provided in said insulator, and said holders engage with said plurality of contacts in the two rows, respectively.
